(19) United States
(12) Patent Application Publication
(10) Pub. No.: US 2006/0261091 A1
(43) Pub. Date: Nov. 23, 2006

(54) Fluid product dispenser

(75) Inventor: Fedor Kadiks, Haarlem (NL)

Correspondence Address: PILLSBURY WINTHROP SHAW PITTMAN, LLP, P.O. BOX 10500, MCLEAN, VA, 22102, US

(73) Assignee: Bentfield Europe B.V., Hillegom (NL)

(21) Appl. No.: 11/332,480

(22) Filed: Jan. 17, 2006

Related U.S. Application Data
(60) Provisional application No. 60/677,352, filed on May 4, 2005.

(51) Int. Cl. B67D 5/38

(52) U.S. Cl. 222/156; 222/181.3; 222/321.7; 222/380; 222/181.1

(57) ABSTRACT

A dispenser for dispensing a fluid product, includes a reservoir for containing a liquid product, a pump, connected to the reservoir, for dispensing the fluid product, using the liquid product as an input, an actuating organ cooperating with the pump, whereby the pump can be actuated by manually moving the actuating organ, at least part of at least an outer surface of the actuating organ being comprised of plastic material, wherein an anti-pathogenic agent is incorporated within said plastic material. For example, the plastic material has a matrix-like molecular structure and the anti-pathogenic agent is distributed substantially homogeneously throughout this matrix-like structure. In a particular embodiment, the anti-pathogenic agent comprises silver, including salts or complexes thereof. The product present in the reservoir as liquid and dispensed by the pump as fluid may, for example, include soap, shampoo, disinfectant, detergent, moisturizer, hair conditioner, exfoliating scrub, perfume, and mixtures of these products.

The present application claims priority to Provisional Application No. 60/677,352, filed May 4, 2005.

### BACKGROUND OF THE INVENTION

1. Field of the Invention

The invention relates generally to a dispenser for dispensing a fluid product and more particularly to such a dispenser including a reservoir for containing a liquid product, a pump, connected to the reservoir, for dispensing the fluid product, using the liquid product as an input, and an actuating organ cooperating with the pump, whereby the pump can be actuated by manually moving the actuating organ, at least part of at least an outer surface of the actuating organ being comprised of plastic material.

2. Description of the Related Art

For purposes of clarity and consistency, the following terms as used throughout this text and the appended claims should be interpreted as follows:

The term “fluid” should be interpreted as encompassing a liquid, a suspension of a granulated solid in a liquid, a gel, a foam, and a spray, for example.

The term “product” should be interpreted as encompassing soap (including shower gel), shampoo, disinfectant (including alcohols), detergent, moisturizer, hair conditioner, exfoliating scrub, and perfume, for example, including mixtures of these substances.

The term “reservoir” refers to any suitable type of container, whether rigid or flexible, such as a bottle, flask, or bag, for example.

The “liquid product” may be dispensed directly through the pump, or may first be mixed with another substance, such as air or another gas, another liquid, or a granulated solid, for example.

The term “pump” refers to any type of pump suitable under the circumstances. The pump in question may employ a piston, bellows, and/or membrane, for example. Alternatively, it may be an aerosol valve.

The term “actuating organ” may comprise a lever, button, hinged part, or wheel, for example. It should be noted that the actuating organ may, if so desired, be an integral part of the pump, such as in the case of a cap on a moving part of the pump.

The term “plastic material” should be interpreted as encompassing thermoplastics, thermo-setting plastics, resins, carbon composites, fiber glass, and rubbers, for example, including combinations/mixtures of two or more of these materials.

Fluid product dispensers of the type described in the opening paragraph are well known, and are described inter alia in U.S. Pat. No. 5,732,853, assigned to current applicant. Such dispensers are, for example, employed in washrooms, toilets, kitchens, hospitals, surgeries, hair/beauty salons, workshops and factories. In many cases, such dispensers are fitted in a holder that is mounted to a wall, often in the vicinity of a basin, bath, shower or toilet bowl; alternatively, such dispensers may be free-standing, and may be placed on a shelf, worktop or wash hand basin, or a trolley. In use, the actuating organ is typically operated by hand, arm or elbow so as to dispense a quantity of fluid product. In many applications, this fluid product will be dispensed into the operator's hand, or onto a carrier such as a tissue or cloth, after which the fluid product is rubbed onto the skin or hair, or is applied from said carrier onto a surface to be sanitized, such as a toilet seat. In other cases, operating the actuating organ will cause a perfume to be dispensed into the general environment of the dispenser in the form of a spray or aerosol, so as to mitigate unpleasant odors in, for example, toilets.

In many cases, dispensers of this type are employed in multi-user environments, such as airports, office buildings, schools, hospitals, sports centers, department stores, etc., so that the actuating organ will be touched by many different users in a given period of time. In other environments, the dispenser will serve a more limited number of users, such as in a doctor's surgery, but the hands of the user in question will be exposed to varied infection risks in a given period of time, such as in the case of a doctor or veterinary surgeon handling multiple patients per day. In both instances, the user may be exposed to pathogens (such as bacteria, viruses or fungi) already present on the actuating organ as a result of a previous operation of the dispenser, whether by a different user or by the same user. Since many pathogens can survive for substantial lengths of time outside of a host organism, such exposure can represent a substantial risk of infection. Examples of such resilient pathogens include the SARS virus, E-coli bacteria, the Foot-and-Mouth virus (in cattle), fungi associated with dermatological infections (such as athlete's foot), wart viruses, etc.

One attempt at mitigating this problem might involve regularly sanitizing the actuating organ, e.g., by wiping or spraying it with liquid detergent or antiseptic; in the case of public buildings, for example, this action might be performed as part of the periodic cleaning roster of a washroom. However, since the actuating organ may still be touched many times between such periodic sanitizing operations, there is still a risk of contamination to users.

### SUMMARY OF THE INVENTION

One aspect of embodiments of the present invention addresses the foregoing problem. More specifically, embodiments of the present invention may provide a dispenser which can be used with a reduced risk of spreading disease.

These and other aspects of embodiments of the invention are achieved in a dispenser as specified in the opening paragraph, and further including an anti-pathogenic agent is incorporated within the plastic material.

### BRIEF DESCRIPTION OF THE DRAWINGS

The invention will now be elucidated in more detail on the basis of exemplary embodiments and the accompanying schematic drawings, in which:

FIG. 1 renders a perspective view of a dispenser according to the invention;

FIG. 2 renders a longitudinal cross-sectional view of the subject of FIG. 1, taken along the line AA′; and

FIG. 3 shows a cross-section of another embodiment of a dispenser according to the invention.

In the Figures, corresponding elements are denoted by corresponding reference symbols.

### DETAILED DESCRIPTION OF THE INVENTION

A dispenser according to embodiments of the present invention has the feature that the actuating organ is self-sanitizing. Pathogens deposited on the actuating organ, e.g., by the contaminated hands of a user, are attacked and neutralized by the anti-pathogenic agent incorporated in the plastic material of the actuating organ, independent of any external attempts to sanitize the actuating organ by cleaning personnel. In this way, the risk of contamination to subsequent users from previous users, and/or the risk of contamination of a single user by pathogens associated with a previous use, may be significantly reduced.

In a particular embodiment of the invention, the plastic material has a matrix-like molecular structure and the anti-pathogenic agent is distributed substantially homogeneously throughout the matrix-like structure. Such an arrangement ensures that the anti-pathogenic agent will be able to work at all surfaces of the plastic material, including surfaces later exposed by drilling or machining, or by cracking or chipping, for example. Moreover, distribution of the anti-pathogenic agent throughout the plastic matrix in this manner is compatible with common manufacturing techniques, such as injection molding. The active lifetime of an anti-pathogenic agent thus distributed throughout the plastic matrix is very satisfactory, and can be of the order of years in certain embodiments; this contrasts strongly with, for example, the case of a liquid detergent applied to the external surface of the actuating organ, which will usually evaporate in a matter of minutes or hours.

A particular embodiment of the invention makes use of an anti-pathogenic agent including silver, including salts or complexes thereof. Silver ions can, for example, react with intercellular enzymes of bacteria, thus adversely affecting respiration. In addition, silver is able to bind to DNA, inhibiting replication or making cells more sensitive to photocatalytic kill. In particular examples, a silver-based anti-pathogenic agent may take the form:
AgₓNa_{(1-x-y)}H_{y}Zr₂(PO₄)₂

or the form:
xAg₂/nO.Al₂O₃.ySiO₂.zH₂O (an aluminum silicate),

in which x, y, z are partial molar amounts.

Alternatives to silver-based inorganic anti-pathogenic agents include, for example:

Inorganic derivatives containing Cu, Zn, Fe, and/or salts or complexes thereof;

Organic derivatives, containing phenol groups and halogen atoms, such as Cl, Br and I;

Phthalate derivatives;

Quaternary ammonium derivatives (cetrimide, dequalinium chloride).

In the case of molded plastic material, the anti-pathogenic agent may be present in the molding compounds in weight percentages ranging from 0.0001 to 10%, preferably from 0.001 to 5%, or more preferably from 0.01 to 1%. The plastic material according to the invention can be prepared by adding the desired amount of the anti-pathogenic agent during any one of the operative steps of a conventional molding process, e.g., during a ball milling or coloring step.

In one embodiment of the invention, the whole actuating organ is comprised of the plastic material referred to above. In an alternative embodiment, however, the actuating organ comprises a bulk part and a surface part, the surface part being removably attached to the bulk part, the surface part comprising the plastic material. This latter embodiment has the feature that it uses less of the anti-pathogenic agent per actuating organ. Moreover, if the dispenser/actuating organ have a very long lifetime, then it is easy to replace a depleted surface part by a fresh surface part once the active lifetime of the anti-pathogenic agent in the depleted surface part has expired. In the former embodiment, one would replace the entire actuating organ by a new one once the active lifetime of the anti-pathogenic agent had expired.

Suitable plastic material for use with the invention includes polypropylene (PP), polyethylene (PE), polyoxymethylene (POM), acrylonitrilebutadienestyrene (ABS), nylon, and mixtures of these materials.

### EMBODIMENT 1

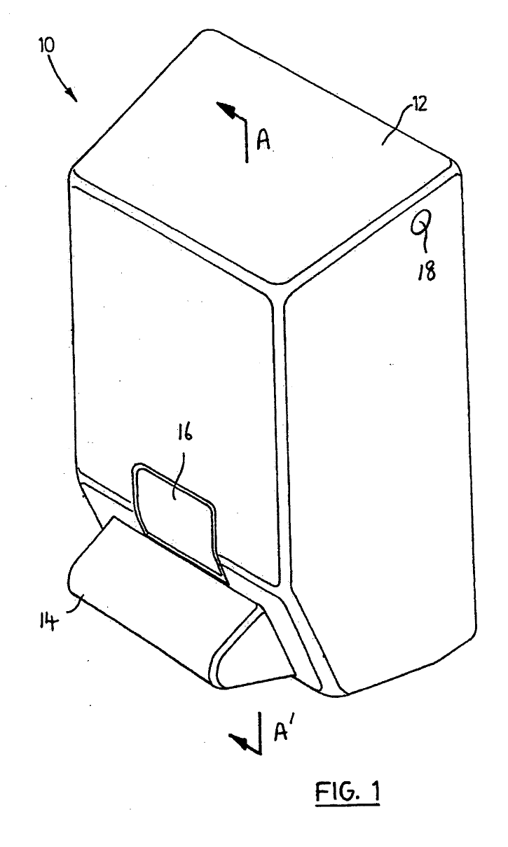

FIG. 1 renders a schematic perspective view of part of a dispenser 10 for dispensing a fluid product, in accordance with the current invention.

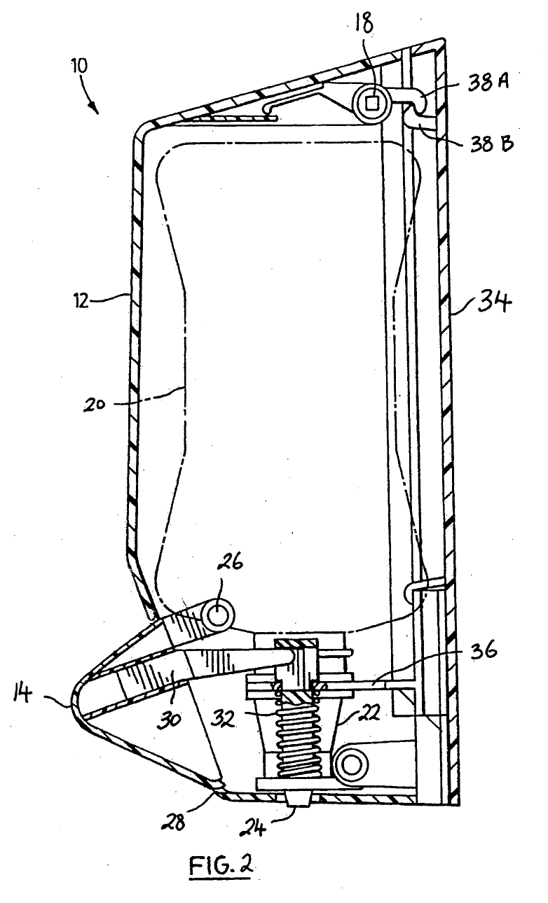

FIG. 1 shows a holder 12, which can be mounted to a wall of a washroom, for example. The holder 12 houses a reservoir 20, for containing a liquid product, and an attached pump 22; these items are only visible in FIG. 2, and will be discussed later in more detail. An actuating organ 14 is movably connected to the holder 12, and can be actuated so as to operate said pump 22. Also shown are an inspection window 16, which allows the amount of liquid in the reservoir 20 to be seen from outside. An aperture 18 allows insertion of a tool with the aid of which the holder can be unlocked and opened, allowing access to the reservoir 20 and pump 22 located within. The actuating organ 14 is made from plastic material, such as polypropylene, for example. The walls of the holder 12 are made from any suitable rigid material, such as metal or a plastic (e.g., ABS).

FIG. 2 renders a cross-sectional view of the subject of FIG. 1, taken along the line AA′. The reservoir 20 is now visible, and may be embodied to be rigid or flexible (e.g., collapsible). It can be made of any suitable material, such as plastic or glass, and may take the form of a bottle, flask, or bag, for example. The liquid product contained in the reservoir 20 may, for example, comprise soap, shower/bath gel, shampoo, disinfectant (including alcohols), detergent, moisturizer, hair conditioner, exfoliating scrub, perfume, or mixtures of these products. The above-mentioned document U.S. Pat. No. 5,732,853 describes such a reservoir, and means by which it can be coupled to a pump.

A pump 22 is connected to the underside of the reservoir 20, so as to be able to draw liquid from within the reservoir 20. The pump 22 may be any suitable type of pump for the application in question, such as a liquid pump, spray pump or foam pump, for example, and may operate on the basis of a movable piston, bellows and/or membrane, for example. In operation, the pump 22 may directly dispense the liquid contained within the reservoir 20, or may first mix it with air to form a spray or foam, for example. In all cases, the pump 22 dispenses a fluid product from the nozzle 24. More information with regard to pumps suitable for use in this type of application can be gleaned from U.S. Pat. No. 5,271,530 (Daiwa Can Company) and U.S. Patent Application Publication No. 2004/0149777 (Taplast), for example.

As can be seen in FIG. 2, the actuating organ 14 in this instance is hinged to the holder 12 via a hinge joint 26. This, together with the gap 28 below the actuating organ 14, means that the actuating organ 14 can be swung in and out of the holder 12. An arm 30 connects the actuating organ 14 to the pump 22 in such a manner that, when the actuating organ 14 is swung into the holder 12 about hinge point 26, arm 30 operates pump 22 so as to dispense a dose of fluid product through the nozzle 24. Biasing means, such as spring 32, ensure that the actuating organ 14 is urged back into its swung-out position when released. In many applications, a user depresses the actuating organ 14 using his hand palm, lower arm or elbow, for example, and collects the fluid product dispensed from the nozzle 24 in his hand or on a carrier (such as a cloth or tissue); in such applications, the nozzle 24 will generally face substantially downward. However, particularly when the liquid product in the reservoir 20 is a perfume and the pump 22 is embodied as a spray pump, the fluid product dispensed through the nozzle 24 may be intended to disperse into the general environment; in such applications, the nozzle may point substantially upward or sideward (generally away from the user).

The pump 22 is removably mounted to a bracket 36 that protrudes from the back wall 34 of the holder 12. This back wall 34 can be provided with screw-holes, magnets, or other means for mounting it to a wall or other surface. Also protruding from the back wall 34 is a lug 38B, which grips a cooperating lug 38A; however, using a tool inserted through aperture 18, these two lugs 38A, 38B can be disengaged, allowing the housing 12 to be opened, e.g., so as to replace the reservoir 20 and/or pump 22 located inside.

In accordance with the invention, the plastic material of the actuating organ 14 comprises an anti-pathogenic agent. For example, the actuating organ is manufactured in an injection-molding process from polypropylene, whereby 0.1 wt. % of an inorganic substance such as AgₓNa_{(1-x-y)} H_{y}Zr₂ (PO₄)₂ is first added to the injection-molding mixture in a ball mill (x,y,z being partial molar amounts). Instead of manufacturing the entire actuating organ 14 from such material, one may instead elect to manufacture just parts of the actuating organ 14 from such material, such as (certain) parts of the surface of the actuating organ 14 that will be touched by the user during actuation; these parts may be designed to be removable and replaceable by new parts, if so desired.

Since, in use, the actuating organ is contacted by human hands or arms, it will be brought into contact with pathogens present on the skin of the user. In the case of a dispenser for dispensing a soap product, this problem is exacerbated by the fact that said contact generally occurs before the user's hands are cleaned and often after they have been involved in unsanitary activity. In accordance with the invention, once such pathogens are deposited on the plastic material of the actuating organ, they are attacked by the anti-pathogenic agent present in the plastic material. As a result, depending on the particular pathogen involved, a substantial and rapid decrease can occur in the population size of the pathogen on the plastic material as a function of time.

### EMBODIMENT 2

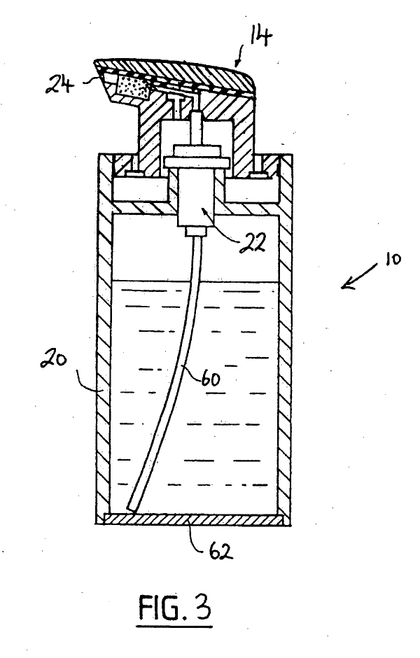

FIG. 3 renders a cross-sectional view of part of a dispenser 10 for dispensing a fluid product, in accordance with another embodiment of the present invention.

A pump 22, for dispensing a fluid product, is connected to a reservoir 20, for containing a liquid product. The reservoir 20 is provided with a hatch 62 that can be opened (e.g., by screwing motion) so as to re-fill the reservoir 20 as necessary. A tube 60 connects the pump 22 to the body of liquid in the reservoir 20, so that the combination can be used in an upright configuration (as illustrated), if desired.

On top of the pump 22, and co-operating therewith, is an actuating organ 14, which comprises plastic material. Pushing the actuating organ 14 downward by hand causes the pump to operate, and dispense a dose of fluid product through the nozzle 24. When the actuating organ 14 is released, (non-depicted) biasing means urge it back upward to its starting position, ready for the next actuation.

Once again, because the actuating organ 14 is actuated by hand, it will be contaminated by pathogens present on the skin of the user. However, by incorporating an anti-pathogenic agent within the plastic material of the actuating organ 14, in accordance with the invention, the chance of passing contamination onto the hand of a subsequent user is substantially diminished.

I claim:

1. A dispenser for dispensing a fluid product, comprising:
a reservoir for containing a liquid product;
a pump, connected to the reservoir, for dispensing the fluid product, using the liquid product as an input;
an actuating organ cooperating with the pump, constructed and arranged such that the pump can be actuated by manually moving the actuating organ, at least part of at least an outer surface of the actuating organ comprising plastic material, wherein an anti-pathogenic agent is incorporated within the plastic material.

2. A dispenser as in claim 1, wherein the plastic material has a matrix-like molecular structure and the anti-pathogenic agent is distributed substantially homogeneously throughout the matrix-like structure.

3. A dispenser as in claim 1, wherein the anti-pathogenic agent comprises silver.

4. A dispenser as in claim 1, wherein the entire actuating organ comprises the plastic material.

5. A dispenser as in claim 1, wherein the actuating organ comprises a bulk part and a surface part, the surface part being removably attached to the bulk part, the surface part including the plastic material.

6. A dispenser as in claim 1, wherein the plastic material is selected from the group consisting of polypropylene, polyethylene, polyoxymethylene, acrylonitrilebutadienestyrene, nylon, and mixtures of these materials.

7. A dispenser as in claim 1, wherein the liquid product is selected from the group consisting of soap, shampoo, disinfectant, detergent, moisturizer, hair conditioner, exfoliating scrub, perfume, and mixtures of these.

8. A dispenser as in claim 1, wherein at least one of the reservoir and the pump is removably encapsulated in a holder, the actuating organ being movably attached to the holder.

9. A dispenser as in claim 1, wherein the holder includes a mounting structure constructed and arranged to mount it to a surface.

10. A holder comprising:
a housing for removably accommodating at least part of at least one of:
a reservoir for containing a liquid product, and
a pump, connectable to the reservoir, for dispensing a fluid product using the liquid product as an input; and
an actuating organ movably connected to the housing and serving to cooperate with the pump, whereby the pump can be actuated by manually moving the actuating organ, at least part of at least an outer surface of the actuating organ being comprised of plastic material, wherein an anti-pathogenic agent is incorporated within the plastic material.

11. A dispenser for dispensing a fluid product, comprising:
a pump, which can be connected to a reservoir for containing a liquid product, the pump serving to dispense a fluid product using the liquid product as an input;
an actuating organ cooperating with the pump, whereby the pump can be actuated by manually moving the actuating organ, at least part of at least an outer surface of the actuating organ being comprised of plastic material, wherein an anti-pathogenic agent is incorporated within the plastic material.
